(19) United States
(12) Patent Application Publication
(10) Pub. No.: US 2025/0360634 A1
(43) Pub. Date: Nov. 27, 2025

(54) VINE ROBOT USING SHAPE MEMORY POLYMER

(71) Applicant: Toyota Motor Engineering & Manufacturing North America, Inc., Plano, TX (US)

(72) Inventors: Yuyang Song, Ann Arbor, MI (US); Umesh N. Gandhi, Farmington Hills, MI (US); Shinnosuke Shimokawa, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/673,410

(22) Filed: May 24, 2024

(51) Int. Cl. B25J 18/06; B25J 9/14; B25J 13/08

(52) U.S. Cl. CPC B25J 18/06; B25J 9/142; B25J 13/08

(57) ABSTRACT

Embodiments described herein relate to a robotic device having controllable shape memory polymers to control a shape of the robotic device. In one embodiment, a robotic device includes a body having a cylindrical shape and formed from a fabric that at least partially retracts within the cylindrical shape of the body. The robotic device including shape units integrated with the body along a length of the body. The shape units include a first polymer on a first side of the body and a second polymer opposing the first polymer on a second side of the body. The shape units control the body to flex at an angle.

### TECHNICAL FIELD

The subject matter described herein relates, in general, to a vine robot, and, more particularly, to a configuration of a vine robot, including sections of shape memory polymers within a structure of the body that function to selectively flex a flexible structure of the body thereby controlling a growth curvature of the body.

### BACKGROUND

Vine robots are robots that simulate the growth mechanism of natural vines. In general, vine robots evert a body to extend along the length from an end/tip of the robot. That is, the body extends itself from an end by turning the body structure out from the end or, in other words, turning inside out. Through the process of everting, the vine robot extends along its length and moves through an environment.

However, the control of vine robots can be a difficult task. That is, controlling a direction of movement is difficult since the robot is generally formed from a flexible material that is, for example, inflated. Accordingly, traditional mechanisms of movement, such as joints, wheels, etc., do not generally function within the context of a vine robot, and, moreover, the general structure of the robot that permits the process of everting can limit the ability robot to include complex structures for controlling the movement. As such, accurately controlling a vine robot remains a complex task.

### SUMMARY

Example embodiments disclosed herein relate to a robotic device, such as a vine robot, having a flexible body structure with shape-memory polymers. For example, in one approach, the flexible body structure is an inflatable structure or other lightweight, flexible structure that is, for example, formed from a fabric. The fabric may be a thermoplastic polyurethane (TPU)-coated nylon or another suitable material. In any case, the body further includes shape units distributed along a length. The shape units include polymers integrated onto the fabric of the body on opposing sides that have different stiffness responses. In one example, the polymers include a combination of acrylate, epoxy, and fumed silica that exhibit strong adhesion to the fabric and can be programmed to respond at different temperatures depending on a specific ratio of the composition. When not activated, the polymers have a stiffness that does not influence the direction in which the body everts and flexes. However, when the device applies a stimulus (e.g., heat), the stiffness of the polymers changes depending on a particular formulation of different compounds. The heat may be applied in different ways depending on the implementation, such as through air/liquid within the body, through heating elements placed proximate to the shape units, etc. Moreover, the body acquires a semi-rigid structure according to a pressure source. The pressure source is, for example, fluid, such as water, air, etc. The device may adjust the pressure of the pressure source between a steady state pressure and an eversion pressure to cause the body of the device to extend.

The shape units can then control how the body everts from the end and can direct the body in different directions depending on, for example, which of the shape units are stimulated according to the heat source. In that regard, the shape units may be placed at different locations along the length of the body, continuously along the body, or in other configurations, and the device can activate the shape units selectively to achieve different shapes within the body. In this way, the robotic device is able to navigate an end of the body as the body emits from the end and grows the device.

In one embodiment, a robotic device is disclosed. The robotic device includes a body that has a cylindrical shape and is formed from a fabric that at least partially retracts within the cylindrical shape of the body. The robotic device includes shape units integrated with the body along a length of the body. The shape units include a first polymer on a first side of the body and a second polymer opposing the first polymer on a second side of the body. The shape units control the body to flex at an angle.

In one embodiment, a vine robot is disclosed. The vine robot includes a body that is cylindrical and formed from a fabric that at least partially retracts within the cylindrical shape of the body. The vine robot includes shape units integrated with the body along a length of the body. The shape units include a first polymer on a first side of the body and a second polymer opposing the first polymer on a second side of the body. The shape units controlling the body to flex at an angle. The vine robot includes a pressure source providing body pressure from a fluid pressure within an interior of the body to maintain the cylindrical shape of the body. The shape units are controlled to selectively flex the cylindrical shape against the body pressure wherein the body extends from an end to change the length according to the fluid pressure increasing above a threshold. The vine robot includes a heat source that provides heat to the shape units to activate the shape units to flex the body. The heat source provides heat at a defined temperature to activate the shape units as defined by a glass transition temperature of the first polymer and the second polymer.

In one embodiment, a device is disclosed. The device includes a body having a cylindrical shape and formed from a fabric that at least partially retracts within the cylindrical shape of the body. The fabric is a thermoplastic polyurethane (TPU)-coated nylon. The body is a flexible structure when inflated according to a fluid pressure. The device includes shape units integrated with the body along a length of the body. The shape units include a first polymer on a first side of the body and a second polymer opposing the first polymer on a second side of the body. The shape units control the body to flex at an angle. The device includes a pressure source providing body pressure from the fluid pressure within an interior of the body to maintain the cylindrical shape of the body. The shape units are controlled to selectively flex the cylindrical shape against the body pressure. The body extends from an end to change the length according to the fluid pressure increasing above a threshold. The device includes a heat source that provides heat to the shape units to activate the shape units to flex the body. The heat source provides heat at a defined temperature to activate the shape units as defined by a glass transition temperature of the first polymer and the second polymer.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A-C illustrate one example of a robotic device at three separate stages.

FIGS. 2A-C illustrate one embodiment of placement of shape units along a length of the body.

FIGS. 3A-C illustrate another embodiment of placement of shape units.

FIG. 4 illustrates a composition of one embodiment of a polymer.

FIG. 5 illustrates one example of systems within a robotic device.

FIG. 6 illustrates one configuration of a control system associated with a robotic device.

### DETAILED DESCRIPTION

Example embodiments disclosed herein relate to a robotic device, such as a vine robot, having a flexible body structure with shape-memory polymers for controlling a shape. As previously noted, difficulties can arise in regard to accurately controlling a robotic device like a vine robot. For example, because of the restricted form of the device and the way in which the device emits additional length through eversion of the body at one end, integrating traditional means for controlling a direction of movement (e.g., joints, etc.) is not generally feasible.

Therefore, in various arrangements, a robotic device uses shape-memory polymers to adapt a stiffness of the body and induce a desired flexing/bending to direct the eversion. For example, in one approach, the flexible body structure is an inflatable structure or another lightweight, flexible structure that is, for example, formed from a fabric. The fabric may be a thermoplastic polyurethane (TPU)-coated nylon or another suitable material. In any case, the body further includes shape units distributed along a length. The shape units include polymers integrated onto the fabric of the body on opposing sides that have different stiffness responses. In one example, the polymers include a combination of acrylate, epoxy, and fumed silica that exhibit strong adhesion to the fabric and can be programmed to respond at different temperatures depending on a specific ratio of the composition. When not activated, the polymers have a stiffness that does not influence the direction in which the body everts and flexes. However, when the device applies a stimulus (e.g., heat), the stiffness of the polymers changes depending on a particular formulation of different compounds. The heat may be applied in different ways depending on the implementation, such as through air/liquid within the body that provides for applying pressure to form a shape of the body, through heating elements placed proximate to the shape units, etc. Moreover, the body acquires a semi-rigid structure according to a pressure source. The pressure source is, for example, fluid, such as water, air, etc. that is contained by the body. The device may adjust the pressure of the pressure source between a steady state pressure and an eversion pressure to cause the body of the device to extend.

The shape units can then control how the body everts from the end and can direct the body in different directions depending on, for example, which of the shape units are stimulated according to the heat source. In that regard, the shape units may be placed at different locations along the length of the body, continuously along the body, or in other configurations, and the device can activate the shape units selectively to achieve different shapes within the body. In this way, the robotic device is able to navigate an end of the body as the body emits from the end and grows the device.

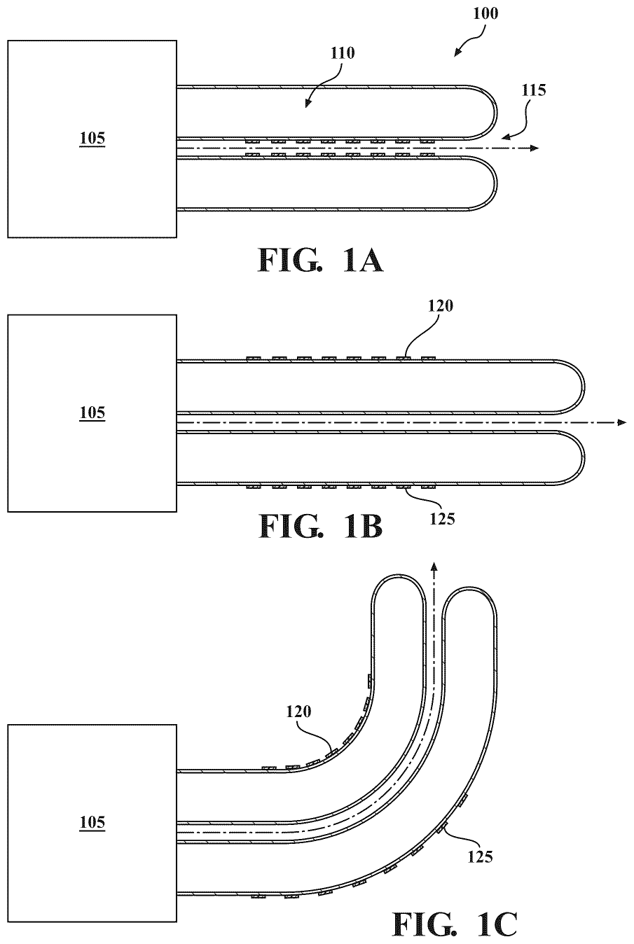

Referring to FIG. 1, an example of a robotic device 100 at three separate stages shown in FIGS. 1A-C. The robotic device 100 is comprised of a base 105 and a body 110, which is shown in a cutaway view. The base 105 is attached to the body 110 of the robotic device 100 and may include various systems of the robotic device 100 that, for example, support different functions. The base 105 secures a proximate end of the body 110 and provides connections for different elements within the body 110. The base 105, in at least one arrangement, includes a pressure source (not illustrated), a heat source (not illustrated), and other elements as will be described subsequently.

The pressure source, in one or more configurations, provides body pressure within the body to inflate or otherwise form the body into a semi-rigid form from an un-inflated form. Thus, the pressure source may provide the body pressure in the form of fluid pressure. As used herein, fluid pressure refers to pressure exerted by either a liquid (e.g., hydraulic) or air (e.g., pneumatic) on walls of the body (e.g., the fabric) that form the body into a defined shape (e.g., cylindrical) as defined by a construction of a body material. The body 110 generally has a cylindrical shape and is composed of, in at least one arrangement, a fabric, such as a thermoplastic polyurethane (TPU)-coated nylon. Of course, in further arrangements, the body 110 may be formed from a different type of material that provides similar characteristics as described.

As shown in stage A of FIG. 1, the robotic device 100 is partially extended. That is, the body 110 of the device 100 begins in a retracted state and extends according to control of the of the device 100. Thus, a portion of the body 110 is folded back into a distal end 115. The body 110 creates an interior cavity running a length of the body 110. It should be appreciated that FIG. 1 shows a side-view cutaway of the body 110, and the un-extended portion of the body 110 would not generally be visible otherwise. In any case, the robotic device 100 extends along a length by forcing additional material of the body 110 from the distal end 115. As will be described further subsequently. One or more sensors may be positioned along the body 110 and/or at the opening at the distal end 115. When positioned at the distal end 115, the sensors or other attachments may extend with the body 110 via an extension mechanism that keeps the sensors in place. For example, as the body everts at the distal end 115, the body 110 may function to push the sensor within an assembly so that the sensor remains in place at the distal end 115. The sensor and sensor assembly may be attached to the base 105 via a wire attached to a reel that allows the sensor to maintain a connection while also permitting the movement of the sensor with the distal end 115.

The robotic device 100, in one arrangement, controls the pressure source to selectively extend the body 110 along the length, as shown in stage B of FIG. 1. For example, if the robotic device 100 determines (e.g., based on various perceptions derived from sensor data) that the body 110 is to move/extend, the robotic device 100 controls the pressure source within the base 105 to apply a fluid pressure that satisfies (e.g., exceeds) a threshold. The threshold is generally defined as a static pressure (i.e., a body pressure) that maintains the body 110 of the robotic device in a semi-rigid form; however, beyond the static/body pressure, the body 110 extends in length by everting from the distal end 115. Accordingly, the robotic device can increase the pressure from the static pressure to an eversion pressure when extending the body 110. In general, the robotic device 100 controls the pressure source to increase the pressure by, for example, activating a pump (e.g., a hydraulic pump, a pneumatic pump, etc.) and sensing the pressure to maintain the pressure at a level that continues to extend the body 110 until reaching a desired length. In this way, the robotic device 100 can control the body 110 to extend and the distal end 115 to move within an environment.

Additionally, as shown in stage C of FIG. 1, the robotic device 100 can control a direction in which the body flexes and thus a direction in which the distal end 115 moves or, stated otherwise, extends. To achieve movement of the body 110 in a desired direction, the device 100 activates shape units that are present on the surface of the body 110. The shape units (i.e., polymers) 120 and 125 are shown in FIG. 1 as an example. In general, a single shape unit is comprised of opposing areas of polymers on the surface of the body 110. In one approach, the polymers are different on each side of the body 110. That is, the polymer 120 may be distinct from the polymer 125. The particular composition of the polymers will be described in greater detail subsequently. However, it should be appreciated that depending on the composition of different compounds within the polymers, the degree of stiffness can be varied when activated. Moreover, a glass transition temperature of the polymers can also be adapted/tuned according to the ratio of compounds included in a respective polymer.

In any case, the robotic device 100 alters the stiffness of the polymers by applying a stimulus to the polymers, such as heat. In one or more arrangements, the base 105 includes a heat source or at least a controller for the heat source. The heat source may take different forms, such as heating elements integrated onto the fabric that are located proximate to the shape units to deliver heat directly to the individual shape units. In further arrangements, the heat source is instead a heating element that heats the fluid (e.g., air or liquid) that is used to inflate the body 110. In the case of heating the fluid, the polymers are activated together. The stage C illustration of FIG. 1 shows how activating the polymers 120 and 125 together causes a change in stiffness of the surface of the body 110 at the location of the polymers 120 and 125, thereby inducing a bending/flexing of the body 110 at this location. Depending on the degree of stiffness, the placement of the shape units, and the manner in which the heat source is implemented to activate all of the shape units or individual shape units, the robotic device 100 is able to control the shape of the body 110 as the body everts from distal end 115. This permits the robotic device to effectively control a direction in which the end 115 extends and thus permits the device to navigate an environment.

Overall, the robotic device 100 may be implemented in different sizes depending on the implementation. In one approach, the body 110 has a diameter of 1.0 cm to 100 cm and may have a length of 0.5 m to 100 m. Thus, the areas of the polymers on the surface may also vary. For example, in one approach, the polymers are placed on the surface of the body 110 in a square shape having a side of, for example, 1 cm to 3 cm depending on the diameter of the body 110. Of course, in further arrangements, the particular shape of the polymer on the surface may vary to include rectangles, ellipses, etc. In any case, the robotic device 100 is able to extend and flex in a unique manner in order to navigate an environment.

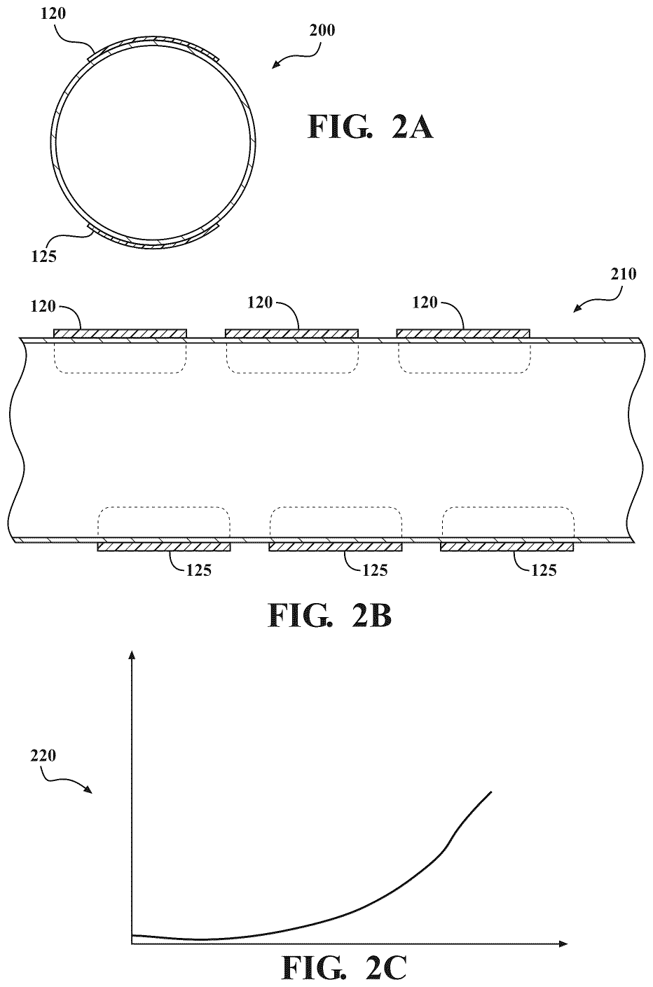

FIG. 2 illustrates a cross-sectional view 200 and a side view 210 of an embodiment of the body 110. In this embodiment, the polymers 120 and 125 are shown opposing each other. The polymers 120/125 form three separate shape units. When the body 110 includes the polymers in the illustrated configuration, the body 110 generally forms the shape shown in the graph 220. The polymers 120/125, as shown in FIG. 2 are generally of a “wide” configuration with limited spacing therebetween, which results in a subtle degree of flexing (e.g., 20 degrees). For example, the polymers 120/125 may have a length of 2 cm with spacing of 0.2 cm therebetween.

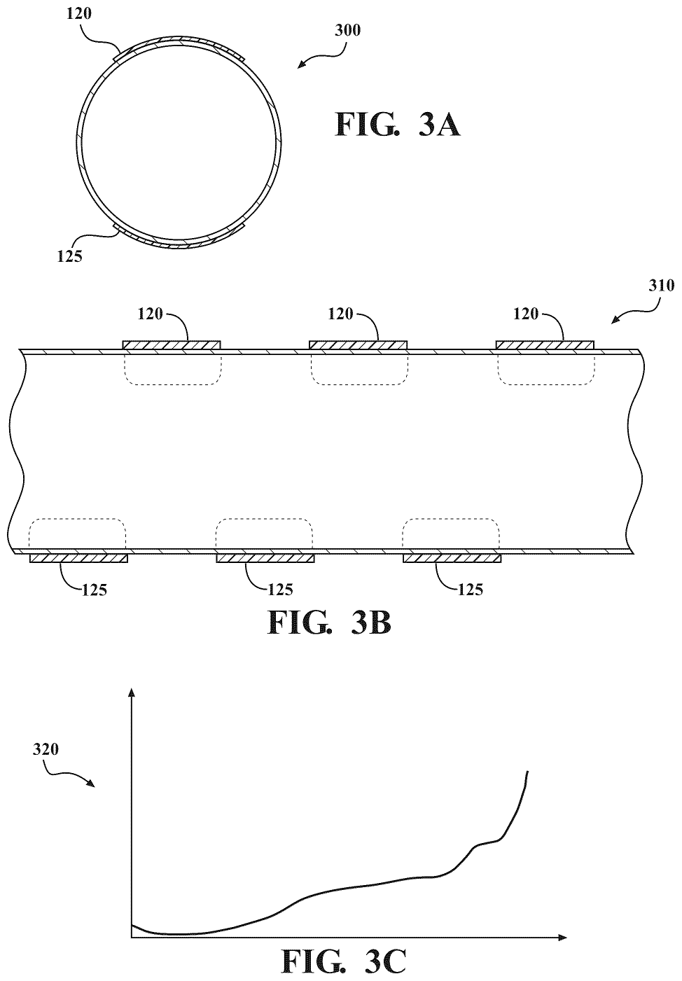

By contrast, FIG. 3 illustrates a cross-sectional view 300 and a side view 310 of an embodiment of the body 110 with different polymer spacing. When the body 110 includes the polymers in the illustrated configuration, the body 110 generally forms the shape shown in the graph 2320. The polymers 120/125, as shown in FIG. 3 are generally of a “narrow” configuration with limited spacing therebetween, which results in a greater degree of flexing (e.g., 30 degrees). For example, the polymers 120/125 may have a length of 1.0 cm with spacing of 1.0 cm therebetween. Thus, in this configuration, the length of the polymer is roughly equal to the spacing therebetween. Accordingly, different sizes and spacing of the polymers 120/125 can result in different flexing of the body when activated. As such, the configuration of the polymers on the surface of the body 110 can be varied in several different ways, including the composition of the polymers, the size of the polymers, and the spacing of the polymers, thereby providing several options for tuning the polymers to facilitate generating different shapes/flexing in the body.

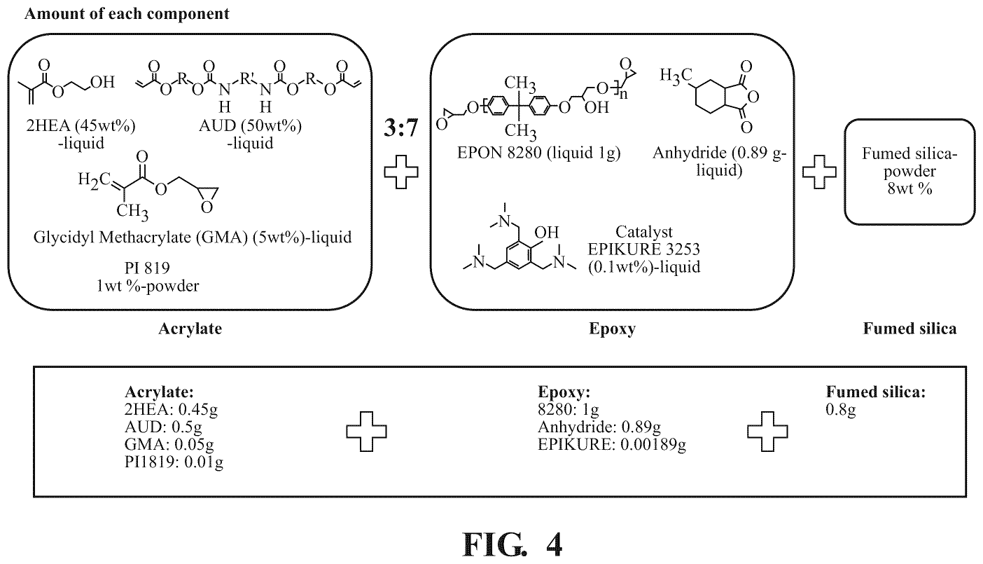

FIG. 4 is a diagram illustrating a composition of one embodiment of a polymer. In the arrangement shown in FIG. 4, the polymer is comprised of acrylate, epoxy, and fumed silica. The separate compositions of the included components and ratios are shown. It should be appreciated that the particular ratios of 3 parts acrylate to 7 parts epoxy can be varied in order to vary the stiffness and glass transitions temperatures. As a further embodiment, the polymer may be comprised of phenylbis (2, 4, 6-trimethylbenzoyl) phosphine oxide, polyethylene glycol diacrylate (PEGDA), acrylate acid and silicon dioxide. In this way, the properties of the device 100 can be varied in order to achieve different performance for flexing and activation of the shape units.

As used herein, a “robotic device” is a non-locomoting but everting apparatus comprised of a body connected with a base. Thus, the “robotic device” is generally a vine robot as provided for herein. While arrangements will be described herein with respect to vine robots, it will be understood that embodiments are not limited to vine robots. As a further note, this disclosure generally discusses the robotic device 100 as navigating through space that is referred to as the surrounding environment of the robotic device 100. Thus, the surrounding environment is intended to be construed broadly as encompassing both indoor and outdoor environments including various other objects (e.g., buildings, vegetation, pedestrians) that may be encountered by the robotic device 100.

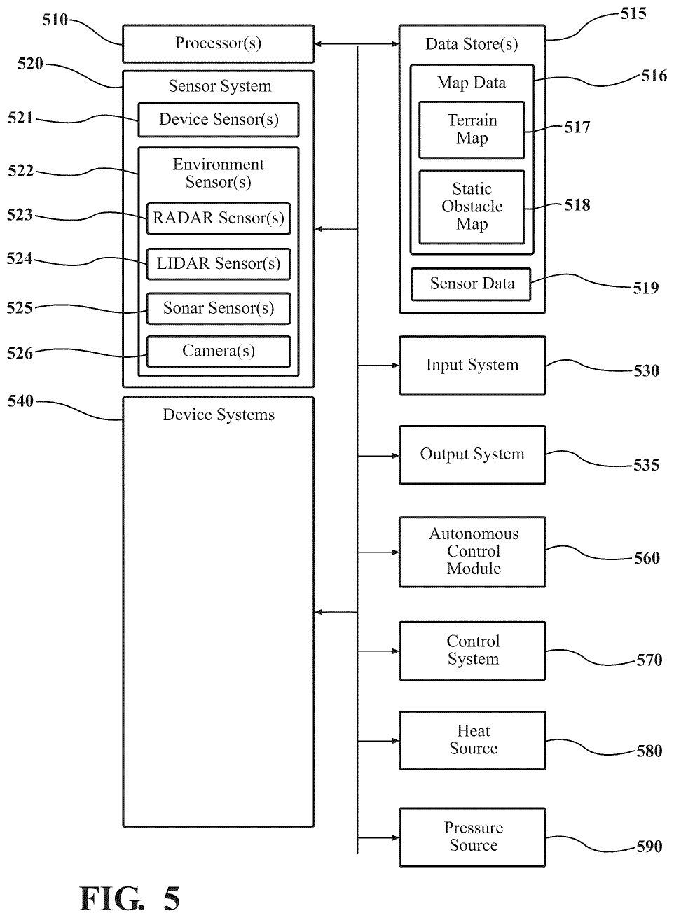

The robotic device 100 also includes various elements. It will be understood that in various embodiments, it may not be necessary for the robotic device 100 to have all of the elements shown and discussed in relation to FIG. 5. The robotic device 100 can have any combination of the various elements shown in FIG. 5. Further, the robotic device 100 can have additional elements to those shown in FIG. 5. In some arrangements, the robotic device 100 may be implemented without one or more of the elements shown in FIG. 1. While the various elements are shown as being located within the robotic device 100 in FIG. 1, it will be understood that one or more of these elements can be located external to the robotic device 100. Further, the elements shown may be physically separated by large distances.

Some of the possible elements of the robotic device 100 are shown in FIG. 5 and will be described along with subsequent figures. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In either case, the robotic device 100 includes a control system 570 that is implemented to perform methods and other functions as disclosed herein relating to controlling a robotic device to flex in defined configurations. The noted functions and methods will become more apparent with a further discussion of the figures. Moreover, the robotic device 100 includes a heat source 580. In one embodiment, the heat source 580 is comprised of a set of heat units that function to impart heat onto the polymers of the shape units of the robotic device 100 in different configurations depending on a particular implementation. In at least one approach, the heat source 580 includes sets of heating elements on each shape unit of the robotic device 100 that are individually controllable. Of course, in further implementations, the system 570 may include different arrangements of the elements, such as fewer sets, and so on. In any case, the control system 570 interfaces with the heat source 580 to selectively activate elements to achieve a desired response in the flexing of the robotic device 100.

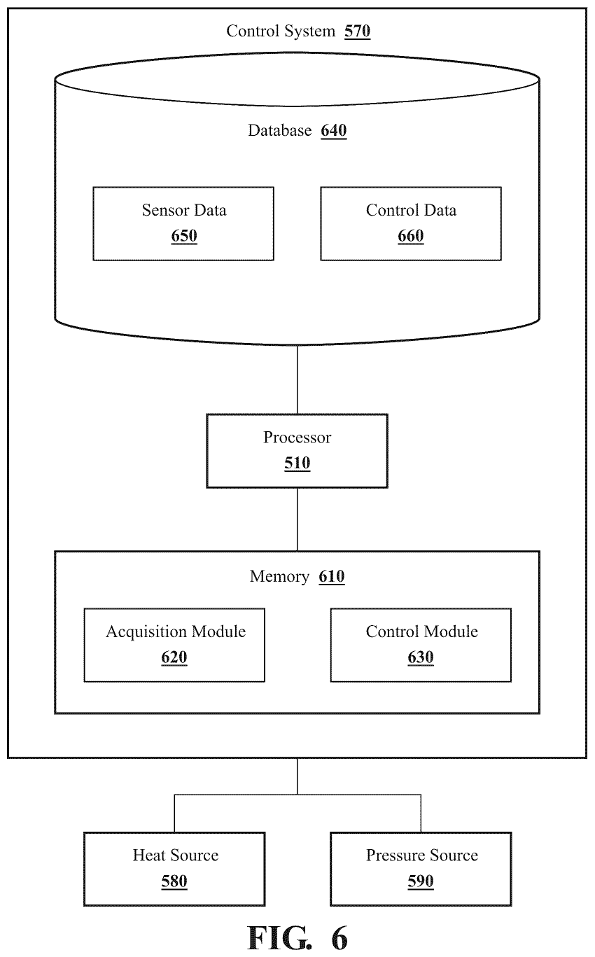

With reference to FIG. 6, one embodiment of the control system 570 of FIG. 5 is further illustrated. The control system 570 is shown as including a processor 510 from the robotic device 100 of FIG. 5. Accordingly, the processor 510 may be a part of the control system 570, the control system 570 may include a separate processor from the processor 510 of the robotic device 100 or the control system 570 may access the processor 510 through a data bus or another communication path. In one approach, the processor 510 is integrated with a controller, an electronic control unit (ECU), or another component of the robotic device 100.

In one embodiment, the control system 570 includes a memory 610 that stores an acquisition module 620 and a control module 630. The memory 610 is a random-access memory (RAM), read-only memory (ROM), a hard-disk drive, a flash memory, or other suitable memory for storing the modules 620 and 630. The modules 620 and 630 are, for example, computer-readable instructions that, when executed by the processor 510, cause the processor 510 to perform the various functions disclosed herein relating to coordinated control of the elements of the heat source 580 and by extension the shape units.

Accordingly, the acquisition module 620 generally includes instructions that function to control the processor 510 to receive or otherwise acquire data inputs from one or more sensors of the robotic device 100 that form sensor data 650, which embodies observations of the surrounding environment of the robotic device 100 including at least surrounding obstacles that may be present. The present discussion will focus on acquiring the sensor data 650 using various sensors that may be integrated with the robotic device 100 including, for example, a camera 526, which remains in place at an everting end of the device 100. However, it should be appreciated that the disclosed approach can be extended to cover further configurations of sensors such as one or more cameras, different types of radars and cameras, combinations of radars and cameras, sonar sensors, the use of a single sensor (e.g., camera), and so on.

Accordingly, the acquisition module 620, in one embodiment, controls the respective sensors to provide the data inputs in the form of the sensor data 650. Additionally, while the acquisition module 620 is discussed as controlling the various sensors to provide the sensor data 650, in one or more embodiments, the acquisition module 620 can employ other techniques to acquire the sensor data 650 that are either active or passive. For example, the acquisition module 620 may passively sniff the sensor data 650 from a stream of electronic information provided by the various sensors to further components within the robotic device 100. Moreover, as previously indicated, the acquisition module 620 can undertake various approaches to fuse data from multiple sensors when providing the sensor data 650. Thus, the sensor data 650, in one embodiment, represents a combination of measurements acquired from multiple sensors.

Additionally, the acquisition module 620, in one embodiment, controls the sensors to acquire the sensor data 650 about an area that encompasses 360 degrees about the robotic device 100 in order to provide a comprehensive assessment of the surrounding environment. Of course, in alternative embodiments, the acquisition module 620 may acquire the sensor data about a forward direction alone when, for example, the robotic device 100 is not equipped with further sensors to include additional regions and/or the additional regions are not scanned due to other reasons (e.g., unnecessary due to known current conditions or occlusions).

Furthermore, in one embodiment, the control system 570 includes the data store 640. The data store 640 is, in one embodiment, an electronic data structure (e.g., a database) stored in the memory 610 or another memory/electronic storage and that is configured with routines that can be executed by the processor 510 for analyzing stored data, providing stored data, organizing stored data, and so on. Thus, in one embodiment, the data store 640 stores data used by the modules 620 and 630 in executing various functions. In one embodiment, the data store 640 includes sensor data 650 and control data 660 along with, for example, other information that is used by the modules 620 and 630. The control data 660 includes, in one approach, a table or other mapping that correlates control inputs from, for example, a remote control, etc. into outputs used by the control system 570 to selectively activate shape units to achieve desired maneuvers/configurations as will be discussed in greater detail subsequently.

The acquisition module 620, in one embodiment, is further configured to perform additional tasks beyond controlling the respective sensors to acquire and provide the sensor data 650. For example, the acquisition module 620 initially analyzes the sensor data 650 to distinguish between aspects of the surrounding environment (e.g., obstacles, etc.). In various approaches, the acquisition module 620 employs different object recognition techniques to identify the surrounding vehicles. The particular technique(s) employed to identify the surrounding vehicles may depend on available sensors within the robotic device 100, computational abilities (e.g., processor power) of the robotic device 100, and so on.

In one approach, the acquisition module 620 uses a machine-learning algorithm embedded within the acquisition module 620, such as a convolutional neural network (CNN), to perform semantic segmentation over the sensor data 650 from which the surrounding obstacles are identified and localized. Of course, in further aspects, the acquisition module 620 may employ different machine-learning algorithms or implements different approaches for performing the semantic segmentation, which can include deep convolutional encoder-decoder architectures, or another suitable approach (e.g., visual-based transformer) that generates semantic labels for the separate object classes represented in the image. Whichever particular approach the acquisition module 620 implements, the acquisition module 620, in one or more embodiments, provides an output identifying the objects including potential hazards represented in the sensor data 650. In this way, the control system 570 distinguishes between objects in the surrounding environment and permits the system 570 to perform additional determinations about the separate objects.

Consequently, the acquisition module 620 is generally capable of identifying the surrounding objects/obstacles in order to acquire measurements about relative positions of the surrounding objects from the sensor data 650. Thus, by way of example, the acquisition module 620, in one approach, initially acquires the sensor data 650, fuses the sensor data 650 from multiple sensors (i.e., registers and combines information), identifies the surrounding objects within the sensor data 650, and then determines measurements to relative positions associated with the surrounding objects.

In any case, the acquisition module 620, in one or more approaches, can acquire and analyze the sensor data 650 in support of, for example, obstacle detection, and/or other such systems that may be included in the robotic device 100, as will be discussed in greater detail in reference to the control module 630 subsequently. Accordingly, the control module 630 generally includes instructions that function to control the processor 510 to execute various actions. For example, in one embodiment, the control module 630 acquires control inputs from an automated system and/or via electronic control inputs (e.g., manual control inputs) and selectively activates one or more of the shape units of the system 570 to achieve a desired maneuver. That is, for example, the controls may specify a simple or complex maneuver, and the control module 630 translates the inputs into selective activations of the shape units in order to support the maneuver.

Thus, the control module 230, in one embodiment, uses a lookup table, a heuristic, or another mechanism to identify which actions of the shape units facilitate control inputs to improve operation. In a further aspect, the control module 230 flexes the body 110 of the robotic device 100 to avoid damage from a collision hazard. For example, the control module 630 can analyze obstacles identfied in the sensor data 650, and determine whether the obstacles represent collision hazards to the robotic device 100 (i.e., an imminent threat of impact/collision). The obstacles can be various aspects of the surrounding environment including surfaces (e.g., ground, walls, etc.), and various objects. By way of example, where the control module 630 determines that the robotic device 100 is everting toward an obstacle, such as wall, the control module 630 may flex the body to maneuver the device along or around the obstacle.

FIG. 5 will now be discussed in full detail as an example environment within which the system and methods disclosed herein may operate. In some instances, the robotic device 100 is configured to switch selectively between an autonomous mode, one or more semi-autonomous operational modes, and/or a manual mode. Such switching can be implemented in a suitable manner. “Manual mode” means that all of or a majority of the navigation and/or maneuvering of the device is performed according to inputs (e.g., electronically received from a user via an input device).

The robotic device 100 can include one or more processors 510. In one or more arrangements, the processor(s) 510 can be a main processor of the robotic device 100. For instance, the processor(s) 510 can be an electronic control unit (ECU). The robotic device 100 can include one or more data stores 515 for storing one or more types of data. The data store 515 can include volatile and/or non-volatile memory. Examples of suitable data stores 515 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 515 can be a component of the processor(s) 510, or the data store 515 can be operatively connected to the processor(s) 510 for use thereby. The term “operatively connected,” as used throughout this description, can include direct or indirect connections, including connections without direct physical contact.

In one or more arrangements, the one or more data stores 515 can include map data 516. The map data 516 can include maps of one or more geographic areas. In some instances, the map data 516 can include information or data on roads, terrain, structures, features, and/or landmarks in the one or more geographic areas or interior spaces. In some instances, the map data 516 can include aerial views of an area. In some instances, the map data 516 can include ground views of an area, including 360-degree ground views. The map data 516 can include measurements, dimensions, distances, and/or information for one or more items included in the map data 516 and/or relative to other items included in the map data 516. The map data 516 can be high quality and/or highly detailed.

In one or more arrangements, the map data 516 can include one or more terrain maps 517. The terrain map(s) 517 can include information about the ground, terrain, roads, surfaces, and/or other features of one or more navigable areas. The terrain map(s) 517 can include elevation data in the one or more geographic areas. The map data 516 can be high quality and/or highly detailed. The terrain map(s) 517 can define one or more ground surfaces, which can roads, floors, passageways, etc.

In one or more arrangements, the map data 516 can include one or more static obstacle maps 518. The static obstacle map(s) 518 can include information about one or more static obstacles/features located within one or more areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 518 can have location data, size data, dimension data, material data, and/or other data associated with it. The static obstacle map(s) 518 can include measurements, dimensions, distances, and/or information for one or more static obstacles. The static obstacle map(s) 518 can be high quality and/or highly detailed. The static obstacle map(s) 518 can be updated to reflect changes within a mapped area.

The one or more data stores 515 can include sensor data 519. In this context, “sensor data” means any information about the sensors that the robotic device 100 is equipped with, including the capabilities and other information about such sensors. The robotic device 100 can include the sensor system 520. The sensor data 519 can relate to one or more sensors of the sensor system 520. As an example, in one or more arrangements, the sensor data 519 can include information on one or more LIDAR sensors 524 of the sensor system 520.

In some instances, at least a portion of the map data 516 and/or the sensor data 519 can be located in one or more data stores 515 located onboard the robotic device 100. Alternatively, or in addition, at least a portion of the map data 516 and/or the sensor data 519 can be located in one or more data stores 515 that are located remotely from the robotic device 100.

As noted above, the robotic device 100 can include the sensor system 520. The sensor system 520 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 520 includes a plurality of sensors, the sensors can work independently from each other. Alternatively, two or more of the sensors can work in combination with each other. In such a case, the two or more sensors can form a sensor network. The sensor system 520 and/or the one or more sensors can be operatively connected to the processor(s) 510, the data store(s) 515, and/or another element of the robotic device 100. The sensor system 520 can acquire data of at least a portion of the external environment of the robotic device 100.

The sensor system 520 can include any suitable type of sensor. Various examples of different types of sensors will be described herein. However, it will be understood that the embodiments are not limited to the particular sensors described. The sensor system 520 can include one or more device sensors 521. The device sensor(s) 521 can detect, determine, and/or sense information about the robotic device 100 itself. In one or more arrangements, the device sensor(s) 521 can be configured to detect, and/or sense position and orientation changes of the robotic device 100, such as, for example, based on inertial acceleration. In one or more arrangements, the device sensor(s) 521 can include one or more accelerometers, one or more gyroscopes, an inertial measurement unit (IMU), a dead-reckoning system, a global navigation satellite system (GNSS), a global positioning system (GPS), and/or other suitable sensors. The device sensor(s) 521 can be configured to detect, and/or sense one or more characteristics of the robotic device 100.

Alternatively, or in addition, the sensor system 520 can include one or more environment sensors 522 configured to acquire, and/or sense environment data. “Environment data” includes data or information about the external environment in which a robotic device, such as a vine robot, is located or one or more portions thereof. For example, the one or more environment sensors 522 can be configured to detect, quantify, and/or sense obstacles in at least a portion of the external environment of the robotic device 100 and/or information/data about such obstacles. Such obstacles may be stationary objects and/or dynamic objects. The one or more environment sensors 522 can be configured to detect, measure, quantify and/or sense other things in the external environment of the robotic device 100, such as, for example, pedestrians, trees/vegetation, utility wires/poles, buildings, vehicles, etc.

Various examples of sensors of the sensor system 520 will be described herein. The example sensors may be part of the one or more environment sensors 522 and/or the one or more vehicle sensors 521. However, it will be understood that the embodiments are not limited to the particular sensors described.

As an example, in one or more arrangements, the sensor system 520 can include one or more radar sensors 523, one or more LIDAR sensors 524, one or more sonar sensors 525, and/or one or more cameras 526. In one or more arrangements, the one or more cameras 526 can be high dynamic range (HDR) cameras or infrared (IR) cameras.

The robotic device 100 can include an input system 530. An “input system” includes any device, component, system, element, or arrangement or groups thereof that enable information/data to be entered into a machine. The robotic device 100 can include an output system 535. An “output system” includes any device, component, or arrangement or groups thereof that enable information/data to be presented to a user via, for example, a wireless controller.

The robotic device 100 can include one or more device systems 540. The robotic device 100 can include various systems in support of the general functionality, such as power management, device monitoring, etc. It should be appreciated that although particular systems are separately defined, each or any of the systems or portions thereof may be otherwise combined or segregated via hardware and/or software within the robotic device 100. Each of these systems can include one or more devices, components, and/or a combination thereof, now known or later developed.

The processor(s) 510, the control system 570, and/or the autonomous control module(s) 560 can be operatively connected to communicate with the various systems 540 and/or individual components thereof. For example, the processor(s) 510 and/or the autonomous control module(s) 560 can be in communication to send and/or receive information from the various systems 540 to control the movement, speed, maneuvering, direction, etc. of the robotic device 100. The processor(s) 510, the control system 570, and/or the autonomous control module(s) 560 may control some or all of these systems 540 and, thus, may be partially or fully autonomous.

The robotic device 100 can include one or more modules, at least some of which are described herein. The modules can be implemented as computer-readable program code that, when executed by a processor 510, implement one or more of the various processes described herein. One or more of the modules can be a component of the processor(s) 510, or one or more of the modules can be executed on and/or distributed among other processing systems to which the processor(s) 510 is operatively connected. The modules can include instructions (e.g., program logic) executable by one or more processor(s) 510. Alternatively, or in addition, one or more data store 515 may contain such instructions.

In one or more arrangements, one or more of the modules described herein can include artificial or computational intelligence elements, e.g., neural network or other machine-learning algorithms. Further, in one or more arrangements, one or more of the modules can be distributed among a plurality of the modules described herein. In one or more arrangements, two or more of the modules described herein can be combined into a single module.

The robotic device 100 can include one or more autonomous control modules 560. The autonomous control module(s) 560 can be configured to receive data from the sensor system 520 and/or any other type of system capable of capturing information relating to the robotic device 100 and/or the external environment of the robotic device 100. In one or more arrangements, the autonomous control module(s) 560 can use such data to generate one or more models. The autonomous control module(s) 560 can determine the location of obstacles, obstacles, or other environmental features including traffic signs, trees, shrubs, vehicles, pedestrians, etc.

The autonomous control module(s) 560 can be configured to receive, and/or determine location information for obstacles within the external environment of the robotic device 100 for use by the processor(s) 510, and/or one or more of the modules described herein to estimate position and orientation of the robotic device 100, position in global coordinates based on signals from a plurality of satellites, or any other data and/or signals that could be used to determine the current state of the robotic device 100 or determine the position of the robotic device 100 with respect to its environment for use in either creating a map or determining the position of the robotic device 100 in respect to map data.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

1. A robotic device, comprising:
a body having a cylindrical shape and formed from a fabric that at least partially retracts within the cylindrical shape of the body; and
shape units integrated with the body along a length of the body, wherein the shape units include a first polymer on a first side of the body and a second polymer opposing the first polymer on a second side of the body, the shape units controlling the body to flex at an angle,
wherein the heat source provides heat to a fluid within the body to activate the shape units, wherein the fluid is a liquid, and wherein the shape units are distributed along the length in separate segments to control the robotic device at different locations along the length, the separate segments being groups of three opposing pairs of the shape units.

2. The robotic device of claim 1, further comprising:
a pressure source providing body pressure from a fluid pressure within an interior of the body to maintain the cylindrical shape of the body, wherein the shape units are controlled to selectively flex the cylindrical shape against the body pressure.

3. The robotic device of claim 1, further comprising:
a heat source that provides heat to the shape units to activate the shape units to flex the body, the heat source providing heat at a defined temperature to activate the shape units as defined by a glass transition temperature of the first polymer and the second polymer.

4. The robotic device of claim , wherein the pairs of the shape units within a respective one of the segments have an inter-segment spacing from about 0.2 cm to about 1.0 cm.

5. The robotic device of claim 3, wherein the heat source includes heating elements disposed proximate to the shape units that, when activated, provide heat to activate the shape units to flex the body.

6. The robotic device of claim 1, wherein the body is a flexible structure when inflated according to fluid pressure, and
wherein the body extends from an end to change the length according to the fluid pressure increasing above a threshold.

7. The robotic device of claim 3, further comprising:
a control system operably connected with the heat source and operable to selectively activate one or more of the shape units to flex the body at a desired location.

8. The robotic device of claim 7, wherein the control system selectively activates the one or more shape units responsive to a control signal to control the robotic device to maneuver.

9. The robotic device of claim 8, wherein the control signal identifies the maneuver as a change in direction for the robotic device.

10. The robotic device of claim 8, wherein the control system generates the control signal in response to identifying an obstacle, and wherein the control system causes the body to flex to route the body around the obstacle.

11. The robotic device of claim 1, wherein the fabric is thermoplastic polyurethane (TPU)-coated nylon, wherein the first polymer and the second polymer are comprised of different ratios of acrylate, epoxy, and fumed silica.

12. The robotic device of claim 1, wherein the separate segments include discrete polymer units having lengths of about 1.0 cm to 2.0 cm.

13. A vine robot, comprising:
a body having a cylindrical shape and formed from a fabric that at least partially retracts within the cylindrical shape of the body;
shape units integrated with the body along a length of the body, wherein the shape units include a first polymer on a first side of the body and a second polymer opposing the first polymer on a second side of the body, the shape units controlling the body to flex at an angle;
a pressure source providing body pressure from a fluid pressure within an interior of the body to maintain the cylindrical shape of the body, wherein the shape units are controlled to selectively flex the cylindrical shape against the body pressure, wherein the body extends from an end to change the length according to the fluid pressure increasing above a threshold; and
a heat source that provides heat to the shape units to activate the shape units to flex the body, the heat source providing heat at a defined temperature to activate the shape units as defined by a glass transition temperature of the first polymer and the second polymer,
wherein the heat source provides heat to a fluid within the body to activate the shape units, wherein the fluid is a liquid, and wherein the shape units are distributed along the length in separate segments to control the robotic device at different locations along the length, the separate segments being groups of three opposing pairs of the shape units.

14. The vine robot of claim 13, wherein the pairs of the shape units within a respective one of the segments have an inter-segment spacing from about 0.2 cm to about 1.0 cm.

15. The vine robot of claim 13, wherein the heat source includes heating elements disposed proximate to the shape units that, when activated, provide heat to activate the shape units to flex the body.

16. The vine robot of claim 13, wherein the fabric is thermoplastic polyurethane (TPU)-coated nylon.

17. The vine robot of claim 13, wherein the body is a flexible structure when inflated according to the fluid pressure.

18. A device, comprising:
a body having a cylindrical shape and formed from a fabric that at least partially retracts within the cylindrical shape of the body, wherein the fabric is thermoplastic polyurethane (TPU)-coated nylon, and wherein the body is a flexible structure when inflated according to a fluid pressure;
shape units integrated with the body along a length of the body, wherein the shape units include a first polymer on a first side of the body and a second polymer opposing the first polymer on a second side of the body, the shape units controlling the body to flex at an angle;
a pressure source providing body pressure from the fluid pressure within an interior of the body to maintain the cylindrical shape of the body, wherein the shape units are controlled to selectively flex the cylindrical shape against the body pressure, wherein the body extends from an end to change the length according to the fluid pressure increasing above a threshold; and
a heat source that provides heat to the shape units to activate the shape units to flex the body, the heat source providing heat at a defined temperature to activate the shape units as defined by a glass transition temperature of the first polymer and the second polymer,
wherein the heat source provides heat to a fluid within the body to activate the shape units, wherein the fluid is a liquid, and wherein the shape units are distributed along the length in separate segments to control the robotic device at different locations along the length, the separate segments being groups of three opposing pairs of the shape units.

19. The device of claim 18, wherein the pairs of the shape units within a respective one of the segments have an inter-segment spacing from about 0.2 cm to about 1.0 cm.

20. The device of claim 18, wherein the heat source includes heating elements disposed proximate to the shape units that, when activated, provide heat to activate the shape units to flex the body.
